(19) United States
(12) Patent Application Publication
(10) Pub. No.: US 2023/0186074 A1
(43) Pub. Date: Jun. 15, 2023

(54) FABRICATING DATA USING CONSTRAINTS TRANSLATED FROM TRAINED MACHINE LEARNING MODELS

(71) Applicant: International Business Machines Corporation, Armonk, NY (US)

(72) Inventors: Oleg BLINDER, Haifa (IL); Michael VINOV, Nofit (IL); Omer Yehuda BOEHM, Haifa (IL); Eyal BIN, Haifa (IL)

(21) Appl. No.: 17/551,533

(22) Filed: Dec. 15, 2021

(51) Int. Cl. G06N 3/08; G06N 3/04; G06N 5/00

(52) U.S. Cl. CPC G06N 3/08; G06N 3/0454; G06N 5/003

(57) ABSTRACT

An example system includes a processor to receive a data set for training a machine learning model. The processor can train the machine learning model on the data set. The processor can also translate the machine learning model into constraint satisfaction problem (CSP) variables and constraints. The processor can generate fabricated data based on the CSP variables and constraints.

### BACKGROUND

The present techniques relate to data synthesis. More specifically, the techniques relate to fabricating data based on structured source data.

Rule-based constraint-driven tools may be used to generate realistic synthetic structured data that can then be used for the development and testing of data-driven applications. For example, such data-driven application may not be able to use real production data due to global regulations on data protection, among other possible reasons.

Some existing tools including rule-guided Constraint Satisfaction Problem (CSP) driven tool, are capable of data fabrication and population of the data into relational database tables, tabular files, or other structural files. As used herein, CSP is a problem formulated in terms of variables and rules, also referred to as constraints, that define valid values for the variables and the relationships between the variables. For example, given a set of variables and constraints, a solution may be a set of a value for each of the variables that satisfies all of the constraints. These tools consume a set of rules, defining dataset dependencies and constraints. Therefore, such rules may typically be provided by the data owner, or a domain expert. This set of rules may also be referred to as a data model. The process of data model definition may be iterative. For example, at each iteration data may be fabricated, examined by comparison to real data, and new rules may then be created, or existing rules improved, to generate better data in the next iteration. Such solutions are sound, but may not be complete. For example, every fabricated data point may be guaranteed to satisfy all of the data constraints. However, such a process may be laborious and time-consuming, and may not even possible in cases where the data is complex.

In addition, in many of today's applications, and certainly in the next generation of applications, data distribution is becoming more and more complex and difficult for a human to explain in order to create the data model, and may include performing data analysis as a prerequisite. Real-world data poses many challenges for a modeler, such as data irregularities and anomalies, where intrinsic data dependencies and constraints are difficult to comprehend. Moreover, the amount of data that requires analysis is getting larger and larger.

### SUMMARY

According to an embodiment described herein, a system can include processor to receive a data set for training a machine learning model. The processor can also further train the machine learning model on the data set. The processor can also translate the machine learning model into a constraint satisfaction problem (CSP) with variables and constraints. The processor can further generate fabricated data based on the CSP. Thus, the system can enable fabricated data to be generated using a CSP solver from constraints automatically generated from a trained machine learning model. Optionally, the processor can populate a data store with the generated fabricated data. In this embodiment, the data store can then be used for testing using the fabricated data. Optionally, the processor can receive user-defined rules, convert the user-defined rules into additional constraints, add the additional constraints to the CSP to generate an updated CSP, and generate the fabricated data based on the updated CSP. In this embodiment, the user-defined rules can be used to control the fabricated data. In various embodiments, the data set includes structured data. In this embodiment, the structured data enables automated training of the machine learning model. Optionally, the trained machine learning model can be a decision tree. In this embodiment, the constraints of the decision tree may be easily translated to CSP constraints. Optionally, the trained machine learning model can be a generator model of a generative adversarial network. Preferably, the generator model is a deep neural network. In this embodiment, the constraints of the deep neural network tree may be translated to CSP constraints.

According to another embodiment described herein, a method can include receiving, via a processor, a data set for training a machine learning model. The method can further include training, via the processor, the machine learning model on the data set. The method can also further include translating, via the processor, the machine learning model into a constraint satisfaction problem (CSP) with variables and constraints. The method can also include generating, via the processor, fabricated data based on the CSP. Thus, the method can enable fabricated data to be generated using a CSP solver from constraints automatically generated from a trained machine learning model. Optionally, the method can include populating a data store with the generated fabricated data. In this embodiment, the data store can then be used for developing and testing using the fabricated data. Optionally, the method can also include receiving user-defined rules, converting the user-defined rules into additional constraints, adding the additional constraints to the CSP to generate an updated CSP, and generating the fabricated data based on the updated CSP. In this embodiment, the user-defined rules can be used to control the fabricated data. Preferably, generating the fabricated data includes iteratively solving the CSP to generate the fabricated data. In this embodiment, any suitable CSP solver may be used to fabricate the data. Optionally, translating the machine learning model includes translating a deep neural network (DNN) into a set of constraints, where each constraint represents a composition of the activation functions from input to output, and where the input for each activation function is the activation of a previous layer multiplied by weights over edges of the DNN. In this embodiment, the constraints of the DNN may be easily translated to CSP constraints. Optionally, translating the machine learning model includes translating conditions in a decision tree model into conditional constraints. In this embodiment, the conditional constraints of the decision tree may be easily translated to CSP constraints. Optionally, the method includes testing a data-driven application using the fabricated data. In this embodiment, the developing and testing with fabricated data enables more data for testing.

According to another embodiment described herein, a computer program product for data fabrication can include computer-readable storage medium having program code embodied therewith. The computer readable storage medium is not a transitory signal per se. The program code executable by a processor to cause the processor to receive a data set for training a machine learning model. The program code can also cause the processor to train the machine learning model on the data set. The program code can also cause the processor to translate the machine learning model into a constraint satisfaction problem (CSP) with variables and constraints. The program code can also cause the processor to generate fabricated data based on the CSP. Thus, the computer program product can enable fabricated data to be generated using a CSP solver from constraints automatically generated from a trained machine learning model. Optionally, the program code can also cause the processor to populate a data store with the generated fabricated data. In this embodiment, the data store can then be used for developing and testing using the fabricated data. Optionally, the program code can also cause the processor to also further receive user-defined rules, convert the user-defined rules into additional constraints, and add the additional constraints to the CSP to generate an updated CSP, where the fabricated data is generated based on the updated CSP. In this embodiment, the user-defined rules can be used to control the fabricated data. Optionally, the program code can cause the processor to iteratively solve the CSP to generate the fabricated data. In this embodiment, any suitable CSP solver may be used to fabricate the data. Optionally, the program code can also cause the processor to translate a deep neural network (DNN) into a set of constraints, where each constraint represents a composition of the activation functions from input to output, and where the input for each activation function is the activation of a previous layer multiplied by weights over edges of the DNN. In this embodiment, the constraints of the DNN may be easily translated to CSP constraints. Optionally, the program code can also cause the processor to translate conditions in a decision tree model into conditional constraints. In this embodiment, the conditional constraints of the DNN may be easily translated to CSP constraints.

According to another embodiment described herein, a method can include receiving, via a processor, a data set for training a machine learning model. The method can include training, via the processor, the machine learning model on the data set. The method can also include translating, via the processor, the machine learning model into a constraint satisfaction problem (CSP) with variables and constraints. The method can also further include receiving, via the processor user defined fabrication rules. The method can include converting the user-defined rules into additional constraints. The method can also further include adding the additional constraints to the CSP to generate an updated CSP. The method can include generating, via the processor, fabricated data based on the updated CSP. Thus, the method can enable fabricated data to be generated using a CSP solver from constraints automatically generated from a trained machine learning model with manual modification. Optionally, a bias in the fabricated data is offset via the user-defined rules. In this embodiment, any potential bias can be removed via the user-defined rules. Optionally, the user-define rules are received in the form of a CSP language. In this embodiment, any suitable CSP solver may then be used to solve the CSP.

According to another embodiment described herein, a method can include receiving, via a processor, fabricated data generated using constraints inferred via a machine learning model. The method can further include developing and testing, via the processor, a data-driven application using the fabricated data. Thus, the method can enable testing of applications using fabricated data generated automatically from constraints of a machine learning model. Preferably, the fabricated data is used in place of real data for the developing and testing of the data-driven application. In this embodiment, the use of fabricated data for testing may improve security of the real data.

### BRIEF DESCRIPTION OF THE SEVERAL VIEWS OF THE DRAWINGS

FIG. 1 is a block diagram of an example system for fabricating data using constraints translated from trained machine learning models;

FIG. 2 is a block diagram of an example generative adversarial network used to train a generator to be translated according to embodiments described herein;

FIG. 3 is an example machine learning model to be translated to a constraint satisfaction problem according to embodiments described herein;

FIG. 4 is an example decision tree model to be translated to a constraint satisfaction problem according to embodiments described herein;

FIG. 5 is a process flow diagram of an example method that can fabricate data using constraints translated from trained machine learning models;

FIG. 6 is a process flow diagram of an example method that can fabricate data using constraints translated from trained machine learning models and additionally provided rules;

FIG. 7 is a process flow diagram of an example method that can develop and test data-driven application using data fabricated using constraints translated from trained machine learning models;

FIG. 8 is a block diagram of an example computing device that can fabricate data using constraints translated from trained machine learning models;

FIG. 9 is a diagram of an example cloud computing environment according to embodiments described herein;

FIG. 10 is a diagram of an example abstraction model layers according to embodiments described herein; and

FIG. 11 is an example tangible, non-transitory computer-readable medium that can fabricate data using constraints translated from trained machine learning models.

### DETAILED DESCRIPTION

According to embodiments of the present disclosure, a system includes a processor to receive a data set for training a machine learning model. The processor can train the machine learning model on the data set. The processor can also translate the machine learning model into constraint satisfaction problem (CSP) variables and constraints. The processor can generate fabricated data based on the CSP variables and constraints. Thus, embodiments of the present disclosure combine the analytic capabilities of Machine Learning (ML) methods with the solving power and precision of a Constraint Satisfaction Problem (CSP) solver. The embodiments thereby enable users to add human-defined constraints to a set of original constraints automatically captured during the generative model training process and thus to create an augmented version of the original dataset. Moreover, in opening the black box of the trained ML model by converting the trained ML model into an equivalent CSP, the embodiments enable avoiding manual data modelling. In addition, the embodiments provide for a more interpretable solution that enables explanations for particular outcomes. The embodiments thereby also provide an automatic way of high-quality modelling of the data, and boosting up modelling efficiency and effectiveness. In various experiments using different types of data sets including both numerical and categorical data fields, the embodiments herein proved to enable fabrication of high quality data.

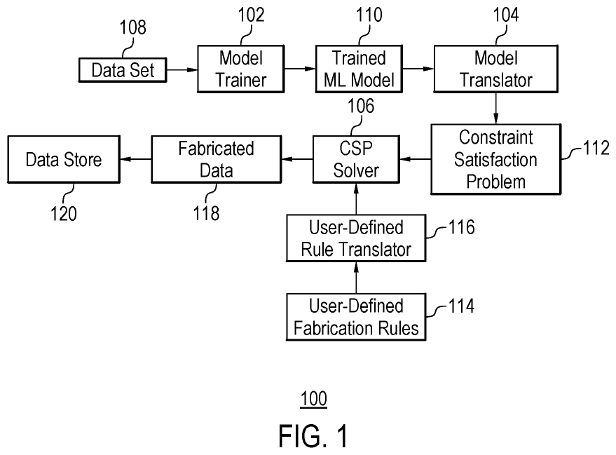

With reference now to FIG. 1, a block diagram shows an example system for fabricating data using constraints translated from trained machine learning models. The example system is generally referred to by the reference number 100. The system 100 includes a model trainer 102 communicatively coupled to a model translator 104. The system 100 also includes a Constraint Satisfaction Problem (CSP) solver 106 communicatively coupled to the model translator 104. For example, the CSP solver 106 may be any suitable CSP solver based on any suitable constraint specification language. The system 100 includes a data set 108 shown being received at the model trainer 102. For example, the data set 108 may include structured source data. As used herein, structured source data is data that conforms to a data model, has a well define structure, follows a consistent order and can be easily accessed and used by a person or a computer program. For example, structured data includes clearly defined data types whose pattern makes them easily searchable. In various examples, the data set 108 may include any number of numerical or categorical data fields, or combination thereof, which may be extracted as features. As one example, the data set 108 may be production data from a database associated with a product. The model trainer 102 is shown generating a trained machine learning (ML) model 110 that is received by the model translator 104. The model translator 104 is shown generating a constraint satisfaction problem (CSP) 112 including variables and constraints, which is shown being sent to the CSP solver 106. For example, the variables may be numeric or categorical variables converted into corresponding numeric variables, and the constraints may be x-variable polynomial constraints, logical constraints, or arithmetical constraints. A set of user-defined fabrication rules 114 is also shown being received at a user-defined rule translator 116 communicatively coupled to the CSP solver 106. The CSP solver 106 is shown generating fabricated data 118. The system 100 also further includes data store 120 that is shown being populated by the fabricated data 118.

In the example of FIG. 1, the system 100 may perform an automatic inference of a data model using a trained ML model 110. In various examples, the trained ML model 110 may be generated by the model trainer 102 using the data set 108. For example, the ML model 110 may be built and trained using the TensorFlow ML framework, version 1.0.0 released February 2017 or version 2.0 released September 2019. The goal of the trained ML model 110 may be to capture the true nature of the data set 108 and provide an accurate estimation for the data distribution of the data set 108. Thus, in various examples, the model trainer 102 may train an ML model 110 over original data set 108, capturing the data distributions, properties, and relationships in a trained ML model 110, until the trained ML model 110 reaches a desired performance. In some examples, the fabricated data 118 may be compared to the original data set 108 using any suitable metric. For example, the comparison may be performed using the Frechet Inception Distance (FID) metric, first introduced 2017. The ML model 110 may thus be a black boxes that show good precision and performance when implicitly learning the original data distribution, properties and intrinsic constraints. In various examples, the performance of the trained ML model 110 can be measured using various metrics to ensure the model is accurate, precise, etc. In various examples, any suitable ML algorithms can be used to construct models that learn the underlying distribution of the data set 108. For example, examples ML algorithms that could be used may include deep neural networks (DNNs), Classification and regression trees (CARTs), Random Forests, Gradient boosted trees, Generative Adversarial Networks (GANs), variational autoencoders (VAEs), Logistic Regression algorithms, and Density-Based Spatial Clustering of Applications with Noise (DBSCAN), among other suitable ML algorithms. In some examples, other ML techniques, such as clustering algorithms, may also be used.

As one detailed example, the trained ML model 110 may be the generator model of a GAN. For example, a GAN architecture may train two models, a generator and discriminator, in a contested process, until some minimum point is reached. For example, the minimum point may one of various local minima at which FID stops improving above a threshold rate. In various, at the minimum point, the generator model learns to generate new data with the same distribution as the data set 108 used for training the GAN.

Still referring to FIG. 1, the model translator 104 may translate the trained ML model 110 into a CSP 112. For example, in the case of a decision tree (DT) model, the model translator 104 can translate conditions in the DT model into conditional constraints. For example, a DT model may be constructed of edges and nodes. Each node may contain a condition indicating what child node to follow. Given a complete DT, the model translator 104 may thus define a constraint for each path starting at the root and ending at a leaf node as a conjunction of the conditions at each node along the path.

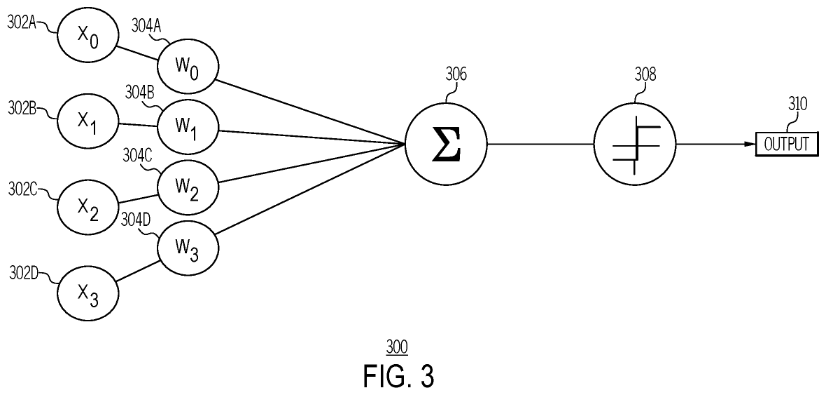

In some examples, the GAN generator may be implemented as a Deep Neural Network (DNN). In various example, the DNN may be an artificial neural network with multiple layers between the input and output layers. For example, each layer of the DNN may also be constructed of edges and nodes. Each edge may have a weight and each node may represent a linear combination, or sum of products, of the layer inputs and the corresponding weights, followed by a non-linear activation function. In various examples, the activation function may be a sigmoid or a rectified linear unit (ReLU) activation function. In these examples, the model translator 104 can translate the DNN into a set of constraints representing the sum of products of inputs and weights mentioned above, followed by a final constraint, representing the non-linear activation function. An example DNN model and its translation into constraints is described with respect to FIG. 3.

In various examples, additional user-defined fabrication rules 114 may be defined by a domain expert and added to the automatically inferred ones received by the CSP solver 106 from the model translator 104. For example, the user-defined fabrication rules 114 may include a set of user-defined constraints. The user-defined fabrication rules 114 may be translated into CSP via the user-defined rule translator 116. Thus, in these examples, the CSP solver 106 may also receive these translated additional rules from the user-defined rule translator 116 as input for generating the fabricated data 118. The user-defined fabrication rules 114 may thus enable users to control the properties of the fabricated data 118.

Once the CSP 112 is extracted out of the trained ML model 110, the CSP solver 106 can generate fabricated data 118 based on the CSP 112. In some examples, the CSP solver 106 may receive and solve the CSP 112 representing the data model. For example, the CSP 112 may be defined as a triple <X, D, C>, where X={X₁, . . . , Xₙ}— a set of variables, D={D₁, . . . , Dₙ}— a set of their respective value domains, and C={C₁, . . . , Cₙ}— a set of constraints (rules).

The CSP solver 106 solves the CSP 112 to generate the fabricated data 118. In various examples, the CSP solver 106 may solve the CSP 112 based on the variables and constraints of the CSP 112 and the user-defined fabrication rules 114, which are added by the CSP solver 106 to the CSP 112. For example, a solution may be defined in which each variable Xᵢ is assigned a singleton value Vi (where Vi ∈ Di), in which all the constraints Ci are satisfied. As one example, given variable integer x {[1, 100] }; variable integer y{[1, 10], 22, [35, 58] }; variable bool b; and constraint b→(x>y); then a couple possible solutions may include b=false, x=1, y=1 and b=true, x=2, y=1. In this manner, the CSP solver 106 solves the constraints over the variables, producing a valid value for each variable. Iterating over this process, the CSP solver 106 produces the fabricated dataset 118.

In various examples, the CSP solver 106 can thus fabricate multiple data points satisfying all the constraints and output these data points as fabricated data 118. The CSP solver 106 can then populate a data store 120, such as a database, with the fabricated data 118. For example, to populate a database, the CSP solver 106 can receive CSP variables corresponding to a converted database schema including columns of the tables in the database and their types. The CSP solver 106 can then solve the CSP including such variables and constraints and the solutions may be populated as records in the database. In this manner, the CSP may populate the database with fabricated data 118 that has a similar distribution and properties as the data set 108. In some examples, the CSP solver 106 may populate the fabricated data 118 into a data stream.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional types of ML models, or additional resource servers, etc.). For example, the user-defined fabrication rules 114 may be omitted. In some examples, the system 100 can also include a data check module ensure that the output data points come from same data distribution as the original data set 108.

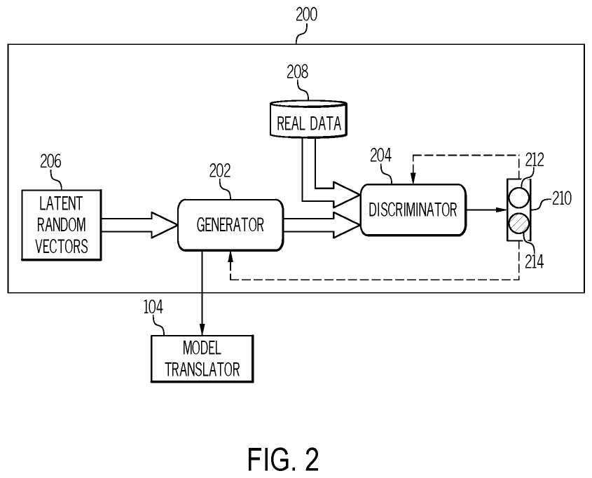

FIG. 2 is a block diagram of an example generative adversarial network used to train a generator to be translated according to embodiments described herein. The generative adversarial network 200 may be used by the model trainer 102 to generate a trained ML model 110.

The generative adversarial network 200 of FIG. 2 includes a generator 202 coupled to a discriminator 204. For example, the generator 202 may be a deep neural network (DNN). The generator 202 is shown receiving latent random vectors 206. For example, the latent random vectors 206 may contain random values sampled from a uniform or normal distribution. The discriminator 204 is shown receiving real data 208 and output from the generator 202. The discriminator 204 is further shown outputting a classification 210. For example, the classification 210 may be real data 212 or fake data 214. FIG. 2 also shows a model translator 104 shown receiving the generator 202 as input. For example, the generator 202 may be used by the model translator 104 to generate CSP variables and constraints as described in FIG. 1.

In the example of FIG. 2, the generator 202 may be trained to receive latent random vectors 206 and generate fabricated data to emulate the real data 212. The discriminator 204 may be simultaneously trained to classify the data output from the generator 202 as real data 212 or fake data 214. For example, as the discriminator 204 improves at classifying real data 212 versus fake data 214, the generator 202 is trained to generate data that is closer to the real data 212 without access to the real data 212. In various examples, in response to detecting that a point of equilibrium is reached, the generator 202 may then be translated into CSP variables and constraints, as described herein.

It is to be understood that the block diagram of FIG. 2 is not intended to indicate that the generative adversarial network 200 is to include all of the components shown in FIG. 2. Rather, the generative adversarial network 200 can include fewer or additional components not illustrated in FIG. 2 (e.g., additional inputs, data, or additional models, etc.).

FIG. 3 is an example machine learning model translated to a constraint satisfaction problem according to embodiments described herein. In some examples, the trained machine learning (ML) model 300 may have been trained by the model trainer 102 of FIG. 1. For example, the ML model may be the trained ML model 110 of FIG. 1. The example ML model 300 includes input variables 302A, 302B, 302C, and 302D. The ML model 300 further includes weights 304A, 304B, 304C, and 304D associated with input values 302A, 302B, 302C, and 302D, respectively. The ML model 300 further includes a net summation function 306. The ML model 300 also further includes an activation function 308. For example, the activation function 308 may be a sigmoid, rectified linear unit (ReLU), or some other non-linear activation function. The ML model further has an output 310.

In various examples, based on an input data set, an ML trainer may have trained an ML model 300 such that its weights describe the distribution of values in the received training data set. In the example of FIG. 3, the input variables 302A-302D ML model 300 may be described using a constraint definition language as:
variable fixedpoint x[4] {[−10.000000, 10.000000]};
variable fixedpoint w[4] {[−100.000000, 100.000000]};
variable fixedpoint wx[4] {[−1000.000000, 1000.000000]};
variable fixedpoint z {[−1000.000000, 1000.000000]};
variable fixedpoint out {[0.000000, 1.000000]};
   where input variables 302A, 302B, 302C, and 302D range from values of −10 to 10, weights 304A, 304B, 304C, and 304D range in value from −100 to 100, and output 310 ranges from 0 to 1.000000. In various examples, the extracted constraints of this example ML model 310 may be defined using the same constraint definition language as:

constraint forEach(i,0,sizeOf(x)−1,wx[i]=w[i]*x[i]);

constraint z=sumOf(i,0,sizeOf(wx)−1,wx[i]);

constraint out=sigmoid(z);

where the output constraint is defined as the sigmoid of the sum of the product of the inputs and their associated weights. In various examples, this extracted CSP may be sent to a CSP solver for generation of fabricated data. In some examples, if the activation function, such as a sigmoid function, of the ML model is not supported by the CSP solver, then an approximation may instead be used.

It is to be understood that the block diagram of FIG. 3 is not intended to indicate that the ML model 300 is to include all of the components shown in FIG. 3. Rather, the ML model 300 can include fewer or additional components not illustrated in FIG. 3 (e.g., additional types of ML models, or additional resource servers, etc.).

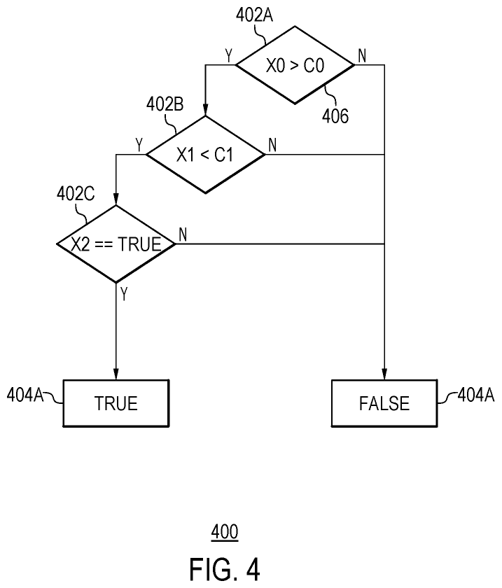

FIG. 4 is an example decision tree model to be translated to a constraint satisfaction problem according to embodiments described herein. In some examples, the trained machine learning (ML) model 300 may have been trained by the model trainer 102 of FIG. 1. For example, the ML model may be the trained ML model 110 of FIG. 1.

The example decision tree model 400 includes decision nodes 402A, 402B, and 402C connected to leaf nodes 404A and 40B. In the example of FIG. 4, C0 and C1 may be decision node constants, while X0, X1, X2 may be variables to solve for. For example, the decisions 402A may include determining whether X0>C0. The decision 402B may include determining whether X1l<C1. The decision 402C may include determining whether X2 is true. The decision nodes 402A is also a root node 406. The decision nodes 402A, 402B, and 402C are connected to leaf nodes 404A and 404B via arrows representing specific decisions.

For example, the decision tree may be described using code:

```
define struct Node0 {
  variable boolean left;
  constraint left = root.x0 > c0;
  define struct Node1 {
    variable boolean left;
    constraint left = root.x1 < c1;
    define home Node2 {
      variable boolean left;
      constraint left = root.x2;
    };
    struct Node2 n2;
  };
  struct Node1 n1;
};
struct Node0 n0.
```

The variables extracted from the decision tree 400 may be defined as:
variable fixedpoint x0 {[0.00, 1000000.00] };
variable integer x1 {[0, 24] };
variable boolean x2 {true, false};
variable boolean answer {true, false};
   The constraint extracted for decision tree 300 may thus be defined as:

constraint answer=n0.left &&n0.n1.left &&n0.n1.n2.1eft;

where an output Boolean value of “answer” is True if and only if all the “left” Boolean variables at each decision node on the tree path leading to this leaf node get the True-value.

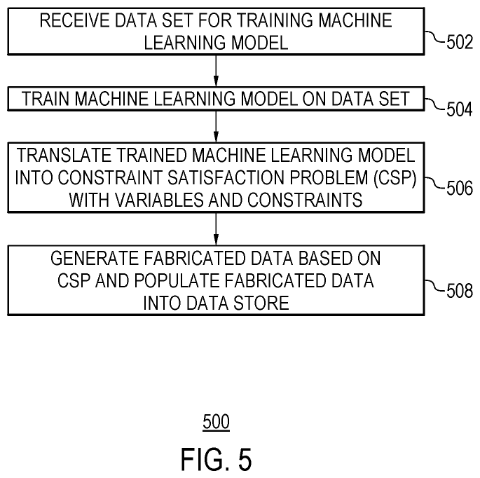

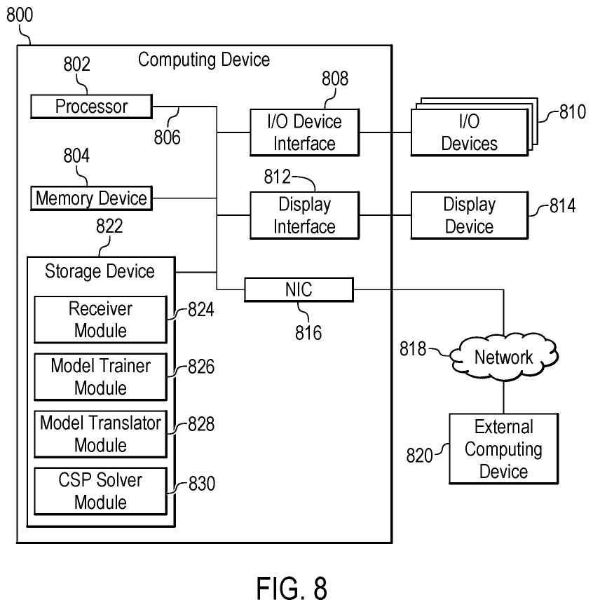

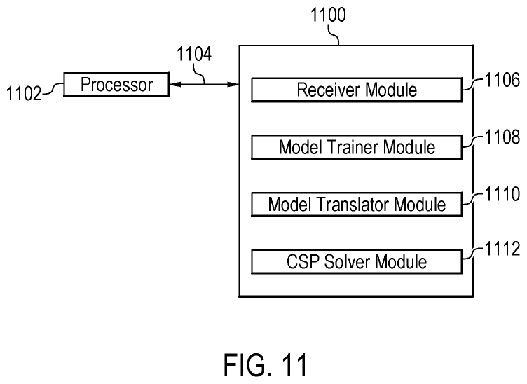

FIG. 5 is a process flow diagram of an example method that can fabricate data using constraints translated from trained machine learning models. The method 500 can be implemented with any suitable computing device, such as the computing device 800 of FIG. 8 and is described with reference to the system 100 of FIG. 1. For example, the method 500 described below can be implemented by the processor 802 or the processor 1102 of FIGS. 8 and 11.

At block 502, a processor receives a data set for training a machine learning model. For example, the data set may include structured data. In some examples, the machine learning model may be a decision tree. In some examples, the machine learning model may be a generator of a generative adversarial network. For example, the generator may be a deep neural network.

At block 504, the processor trains the machine learning model on the data set. For example, the processor may train a DNN to calculate a set of weights for the DNN. In various examples, a tree model may be trained by building a tree structure, chaining down the decision tree nodes of the tree structure, and calculating the decision conditions for each node.

At block 506, the processor translates the machine learning model into constraint satisfaction problem (CSP) with variables and constraints. In some examples, the processor can translate a deep neural network (DNN) into a set of constraints in which each constraint represents a composition of the activation functions from input to output. For example, the input for each activation function is the activation of a previous layer multiplied by weights over edges of the DNN. In some examples, the processor can translate conditions in a decision tree model into conditional constraints.

At block 508, the processor generates fabricated data based on the CSP and populates a data store with the generated fabricated data. For example, the data store may be a database or a file system. In some examples, the fabricated data may be streamed in a data stream. In various examples, the processor can iteratively solve the CSP to generate the fabricated data.

The process flow diagram of FIG. 5 is not intended to indicate that the operations of the method 500 are to be executed in any particular order, or that all of the operations of the method 500 are to be included in every case. Additionally, the method 500 can include any suitable number of additional operations. For example, the method 500 may further include testing a data-driven application using the fabricated data.

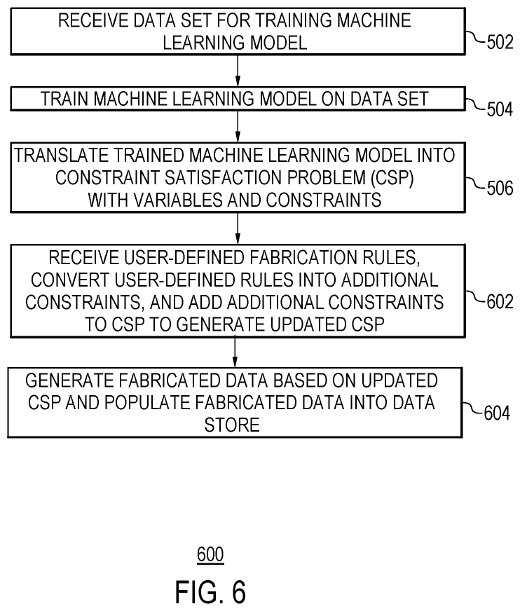

FIG. 6 is a process flow diagram of an example method that can fabricate data using constraints translated from trained machine learning models and additionally provided rules. The method 600 can be implemented with any suitable computing device, such as the computing device 800 of FIG. 8 and is described with reference to the system 100 of FIG. 1. For example, the method 600 described below can be implemented by the processor 802 or the processor 1102 of FIGS. 8 and 11.

At blocks 502-506, the processor may execute as described with respect to FIG. 5. For example, the processor can receive a data set for training a machine learning model, train the machine learning model on the data set, and translate the machine learning model into constraint satisfaction problem (CSP) with variables and constraints.

At block 602, the processor receives user-defined rules, converts the user-defined rules into additional constraints, and adds the additional constraints to the CSP. The user-defined rules may be received from a user and used to control the properties of the fabricated data. For example, the user-defined rules may be used to offset a bias in the original data set such that the fabricated data does not include the bias. In various examples, the user-defined rules may be provided in the same format as the CSP constraints. For example, the user-defined rules may be formatted using the any suitable CSP language.

At block 604, the processor generates the fabricated data based on the updated CSP, and populates the fabricated data into a data store. For example, the data store may be a database or a file system. In some examples, the fabricated data may be streamed in a data stream.

The process flow diagram of FIG. 6 is not intended to indicate that the operations of the method 600 are to be executed in any particular order, or that all of the operations of the method 600 are to be included in every case. Additionally, the method 600 can include any suitable number of additional operations. For example, the method 500 may further include testing a data-driven application using the fabricated data. In some examples, blocks 602 and 604 may be repeated in an iterative manner in order to iteratively adjust and improve properties of the fabricated data.

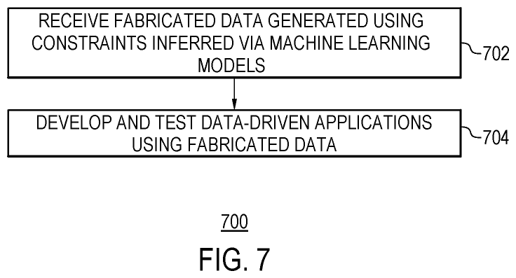

FIG. 7 is a process flow diagram of an example method that can develop and test data-driven application using data fabricated using constraints translated from trained machine learning models. The method 700 can be implemented with any suitable computing device, such as the computing device 800 of FIG. 8 and is described with reference to the system 100 of FIG. 1. For example, the method 700 described below can be implemented by the processor 802 or the processor 1102 of FIGS. 8 and 11.

At block 702, a processor receives fabricated data generated using constraints inferred via machine learning models. For example, the fabricated data may have been generated using the methods 400 or 500 of FIGS. 4 and 5.

At block 704, the processor develops and tests data-driven applications using the fabricated data. For example, the fabricated data may be used instead of real product data, which may not be available for testing the data-driven applications for any variety of reasons.

The process flow diagram of FIG. 7 is not intended to indicate that the operations of the method 700 are to be executed in any particular order, or that all of the operations of the method 700 are to be included in every case. Additionally, the method 700 can include any suitable number of additional operations.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 8 is block diagram of an example computing device that can fabricate data using constraints translated from trained machine learning models. The computing device 800 may be for example, a server, desktop computer, laptop computer, tablet computer, or smartphone. In some examples, computing device 800 may be a cloud computing node. Computing device 800 may be described in the general context of computer system executable instructions, such as program modules, being executed by a computer system. Generally, program modules may include routines, programs, objects, components, logic, data structures, and so on that perform particular tasks or implement particular abstract data types. Computing device 800 may be practiced in distributed cloud computing environments where tasks are performed by remote processing devices that are linked through a communications network. In a distributed cloud computing environment, program modules may be located in both local and remote computer system storage media including memory storage devices.

The computing device 800 may include a processor 802 that is to execute stored instructions, a memory device 804 to provide temporary memory space for operations of said instructions during operation. The processor can be a single-core processor, multi-core processor, computing cluster, or any number of other configurations. The memory 804 can include random access memory (RAM), read only memory, flash memory, or any other suitable memory systems.

The processor 802 may be connected through a system interconnect 806 (e.g., PCI®, PCI-Express®, etc.) to an input/output (I/O) device interface 808 adapted to connect the computing device 800 to one or more I/O devices 810. The I/O devices 810 may include, for example, a keyboard and a pointing device, wherein the pointing device may include a touchpad or a touchscreen, among others. The I/O devices 810 may be built-in components of the computing device 800, or may be devices that are externally connected to the computing device 800.

The processor 802 may also be linked through the system interconnect 806 to a display interface 812 adapted to connect the computing device 800 to a display device 814. The display device 814 may include a display screen that is a built-in component of the computing device 800. The display device 814 may also include a computer monitor, television, or projector, among others, that is externally connected to the computing device 800. In addition, a network interface controller (NIC) 816 may be adapted to connect the computing device 800 through the system interconnect 806 to the network 818. In some embodiments, the NIC 816 can transmit data using any suitable interface or protocol, such as the internet small computer system interface, among others. The network 818 may be a cellular network, a radio network, a wide area network (WAN), a local area network (LAN), or the Internet, among others. An external computing device 820 may connect to the computing device 800 through the network 818. In some examples, external computing device 820 may be an external webserver 820. In some examples, external computing device 820 may be a cloud computing node.

The processor 802 may also be linked through the system interconnect 806 to a storage device 822 that can include a hard drive, an optical drive, a USB flash drive, an array of drives, or any combinations thereof. In some examples, the storage device may include a receiver module 824, a model trainer module 826, a model translator module 828, and a constraint satisfaction problem (CSP) solver module 830. The receiver module 824 can receive a data set for training a machine learning model. For example, the data set may include structured data. In some examples, the receiver module 824 can also receive user-defined rules. The model trainer module 826 can train the machine learning model on the data set. For example, the trained machine learning model may be a decision tree. In some examples, the trained machine learning model may be a generator model of a generative adversarial network. For example, the generator model may a deep neural network. The model translator module 828 can translate the machine learning model into a constraint satisfaction problem (CSP) with variables and constraints. The CSP solver module 830 can generate fabricated data based on the CSP. In some examples, the CSP solver module 830 can receive user-defined rules, convert the user-defined rules into additional constraints, add the additional constraints to the CSP to generate an updated CSP, and generate the fabricated data based on the updated CSP. In various examples, the CSP solver module 830 can populate a data store with the generated fabricated data. For example, the data store may be a database or a file system.

It is to be understood that the block diagram of FIG. 8 is not intended to indicate that the computing device 800 is to include all of the components shown in FIG. 8. Rather, the computing device 800 can include fewer or additional components not illustrated in FIG. 8 (e.g., additional memory components, embedded controllers, modules, additional network interfaces, etc.). Furthermore, any of the functionalities of the receiver module 824, the model trainer module 826, the model translator module 828, and the CSP solver module 830, may be partially, or entirely, implemented in hardware and/or in the processor 802. For example, the functionality may be implemented with an application specific integrated circuit, logic implemented in an embedded controller, or in logic implemented in the processor 802, among others. In some embodiments, the functionalities of the receiver module 824, the model trainer module 826, the model translator module 828, and the CSP solver module 830 can be implemented with logic, wherein the logic, as referred to herein, can include any suitable hardware (e.g., a processor, among others), software (e.g., an application, among others), firmware, or any suitable combination of hardware, software, and firmware.

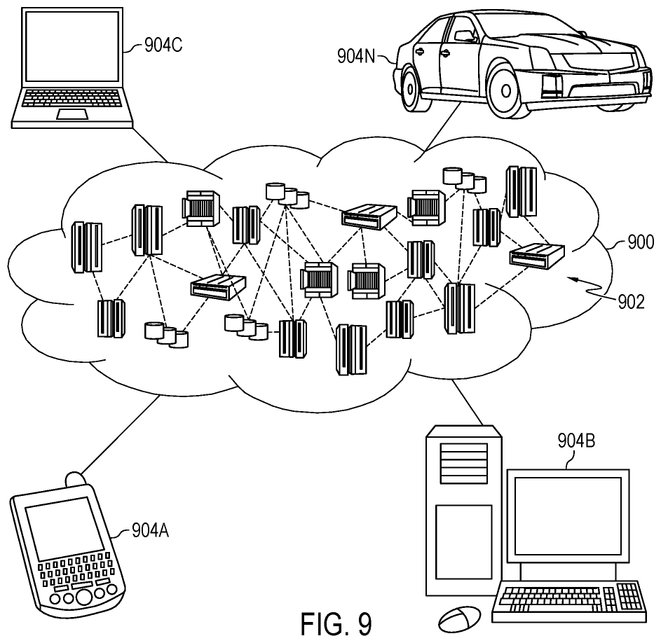

Referring now to FIG. 9, illustrative cloud computing environment 900 is depicted. As shown, cloud computing environment 900 includes one or more cloud computing nodes 902 with which local computing devices used by cloud consumers, such as, for example, personal digital assistant (PDA) or cellular telephone 904A, desktop computer 904B, laptop computer 904C, and/or automobile computer system 904N may communicate. Nodes 902 may communicate with one another. They may be grouped (not shown) physically or virtually, in one or more networks, such as Private, Community, Public, or Hybrid clouds as described hereinabove, or a combination thereof. This allows cloud computing environment 900 to offer infrastructure, platforms and/or software as services for which a cloud consumer does not need to maintain resources on a local computing device. It is understood that the types of computing devices 904A-N shown in FIG. 9 are intended to be illustrative only and that computing nodes 902 and cloud computing environment 900 can communicate with any type of computerized device over any type of network and/or network addressable connection (e.g., using a web browser).

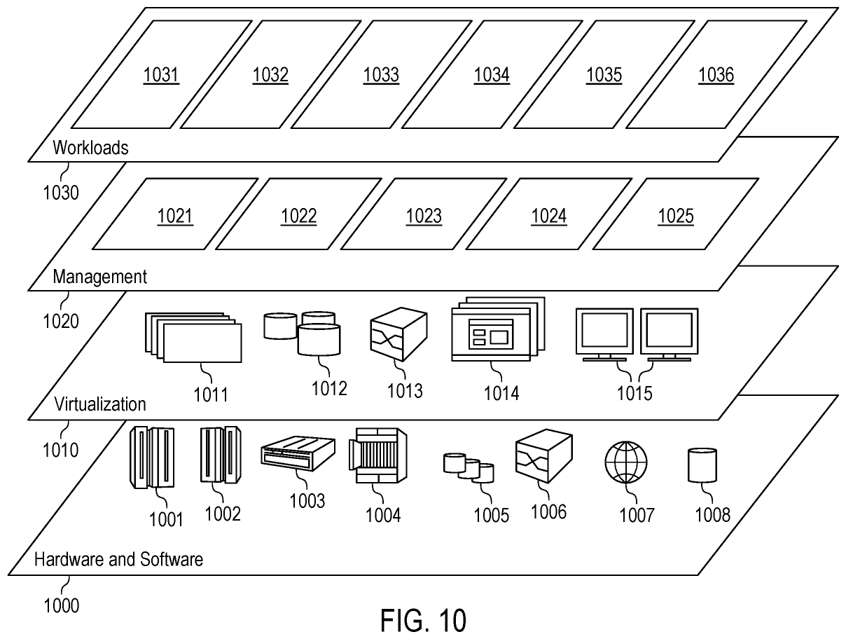

Referring now to FIG. 10, a set of functional abstraction layers provided by cloud computing environment 900 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1000 includes hardware and software components. Examples of hardware components include: mainframes 1001; RISC (Reduced Instruction Set Computer) architecture based servers 1002; servers 1003; blade servers 1004; storage devices 1005; and networks and networking components 1006. In some embodiments, software components include network application server software 1007 and database software 1008.

Virtualization layer 1010 provides an abstraction layer from which the following examples of virtual entities may be provided: virtual servers 1011; virtual storage 1012; virtual networks 1013, including virtual private networks; virtual applications and operating systems 1014; and virtual clients 1015.

In one example, management layer 1020 may provide the functions described below. Resource provisioning 1021 provides dynamic procurement of computing resources and other resources that are utilized to perform tasks within the cloud computing environment. Metering and Pricing 1022 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1023 provides access to the cloud computing environment for consumers and system administrators. Service level management 1024 provides cloud computing resource allocation and management such that required service levels are met. Service Level Agreement (SLA) planning and fulfillment 1025 provide pre-arrangement for, and procurement of, cloud computing resources for which a future requirement is anticipated in accordance with an SLA.

Workloads layer 1030 provides examples of functionality for which the cloud computing environment may be utilized. Examples of workloads and functions which may be provided from this layer include: mapping and navigation 1031; software development and lifecycle management 1032; virtual classroom education delivery 1033; data analytics processing 1034; transaction processing 1035; and data synthesis 1036.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Referring now to FIG. 11, a block diagram is depicted of an example tangible, non-transitory computer-readable medium 1100 that can fabricate data using constraints translated from trained machine learning models. The tangible, non-transitory, computer-readable medium 1100 may be accessed by a processor 1102 over a computer interconnect 1104. Furthermore, the tangible, non-transitory, computer-readable medium 1100 may include code to direct the processor 1102 to perform the operations of the methods 500-700 of FIGS. 5-7.

The various software components discussed herein may be stored on the tangible, non-transitory, computer-readable medium 1100, as indicated in FIG. 11. For example, a receiver module 1106 includes code to receive a data set for training a machine learning model. The module 1106 also includes code to receive user-defined rules. A model trainer module 1108 includes code to train the machine learning model on the data set. A model translator module 1110 includes code to translate the machine learning model into constraint satisfaction problem (CSP) including variables and constraints. In some examples, the model translator module 1110 includes code to translate a deep neural network (DNN) into a set of constraints in which each constraint represents a composition of the activation functions from input to output, where the input for each activation function is the activation of a previous layer multiplied by weights over edges of the DNN. For example, the trained machine learning model may be a DNN trained as a generator in a generative adversarial network. In some examples, the model translator module 1110 includes code to translate conditions in a decision tree model into conditional constraints. For example, the trained machine learning model may be a decision tree. A constraint satisfaction problem (CSP) solver module 1112 includes code to generate fabricated data based on the CSP. In various examples, the CSP solver module 1112 also includes code to iteratively solve the formulated CSP to generate the fabricated data. In various examples, the CSP solver module 1112 also include code to generate the fabricated data based on an updated CSP. For example, the CSP solver module 1112 may include code to convert user-defined rules into additional constraints, add the additional constraints to the CSP to generate an updated CSP, and solve the updated CSP. In some examples, the CSP solver module 1112 also include code to populate a data store with the generated fabricated data. For example, the data store may be a database or a file system.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 11 may be included within the tangible, non-transitory, computer-readable medium 1100, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a data set for training a machine learning model;
train the machine learning model on the data set;
translate the machine learning model into a constraint satisfaction problem (CSP) with variables and constraints; and
generate fabricated data based on the CSP.

2. The system of claim 1, wherein the processor is to populate a data store with the generated fabricated data.

3. The system of claim 1, wherein the processor is to receive user-defined rules, convert the user-defined rules into additional constraints, add the additional constraints to the CSP to generate an updated CSP, and generate the fabricated data based on the updated CSP.

4. The system of claim 1, wherein the data set comprises structured data.

5. The system of claim 1, wherein the trained machine learning model comprises a decision tree.

6. The system of claim 1, wherein the trained machine learning model comprises a generator model of a generative adversarial network.

7. The system of claim 6, wherein the generator model is a deep neural network.

8. A computer-implemented method, comprising:
receiving, via a processor, a data set for training a machine learning model;
training, via the processor, the machine learning model on the data set;
translating, via the processor, the machine learning model into a constraint satisfaction problem (CSP) with variables and constraints; and
generating, via the processor, fabricated data based on the CSP.

9. The computer-implemented method of claim 8, comprising populating, via the processor, a data store with the generated fabricated data.

10. The computer-implemented method of claim 8, comprising receiving, via the processor, user-defined rules, converting the user-defined rules into additional constraints, adding the additional constraints to the CSP to generate an updated CSP, and generating the fabricated data based on the updated CSP.

11. The computer-implemented method of claim 8, wherein generating the fabricated data comprises iteratively solving the CSP to generate the fabricated data.

12. The computer-implemented method of claim 8, wherein translating the machine learning model comprises translating a deep neural network (DNN) into a set of constraints, wherein each constraint represents a composition of the activation functions from input to output, and wherein the input for each activation function is the activation of a previous layer multiplied by weights over edges of the DNN.

13. The computer-implemented method of claim 8, wherein translating the machine learning model comprises translating conditions in a decision tree model into conditional constraints.

14. The computer-implemented method of claim 8, comprising testing, via the processor, a data-driven application using the fabricated data.

15. A computer program product for data fabrication, the computer program product comprising a computer-readable storage medium having program code embodied therewith,
wherein the computer-readable storage medium is not a transitory signal per se, the program code executable by a processor to cause the processor to:
receive a data set for training a machine learning model;
train the machine learning model on the data set;
translate the machine learning model into a constraint satisfaction problem (CSP) with variables and constraints; and
generate fabricated data based on the CSP.

16. The computer program product of claim 15, further comprising program code executable by the processor to populate a data store with the generated fabricated data.

17. The computer program product of claim 15, further comprising program code executable by the processor to receive user-defined rules, convert the user-defined rules into additional constraints, and add the additional constraints to the CSP to generate an updated CSP, wherein the fabricated data is generated based on the updated CSP.

18. The computer program product of claim 15, further comprising program code executable by the processor to iteratively solve the CSP to generate the fabricated data.

19. The computer program product of claim 15, further comprising program code executable by the processor to translate a deep neural network (DNN) into a set of constraints, wherein each constraint represents a composition of the activation functions from input to output, and wherein the input for each activation function is the activation of a previous layer multiplied by weights over edges of the DNN.

20. The computer program product of claim 15, further comprising program code executable by the processor to translate conditions in a decision tree model into conditional constraints.

21. A computer-implemented method, comprising:
receiving, via a processor, a data set for training a machine learning model;
training, via the processor, the machine learning model on the data set;
translating, via the processor, the machine learning model into a constraint satisfaction problem (CSP) with variables and constraints;
receiving, via the processor user defined fabrication rules;
converting, via the processor, the user-defined rules into additional constraints;
adding, via the processor, the additional constraints to the CSP to generate an updated CSP; and
generating, via the processor, fabricated data based on the updated CSP.

22. The computer-implemented method of claim 21, wherein a bias in the fabricated data is offset via the user-defined rules.

23. The computer-implemented method of claim 21, wherein the user-define rules are received in the form of a CSP language.

24. A computer-implemented method, comprising:
receiving, via a processor, fabricated data generated using constraints inferred via a machine learning model; and
developing and testing, via the processor, a data-driven application using the fabricated data.

25. The computer-implemented method of claim 24, wherein the fabricated data is used in place of real data for the developing and testing of the data-driven application.
